(19) United States
(12) Patent Application Publication
(10) Pub. No.: US 2006/0132576 A1
(43) Pub. Date: Jun. 22, 2006

(54) Optical media with laminated inkjet receptor

(76) Inventors: David C. Lowery, Roberts, WI (US); Gary L. Featherstone, Maplewood, MN (US); Arne B. Boberg, Shoreview, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/169,321

(22) Filed: Jun. 28, 2005

Related U.S. Application Data
(60) Provisional application No. 60/638,654, filed on Dec. 22, 2004.

(51) Int. Cl. B41J 3/407

(52) U.S. Cl. 347/106

(57) ABSTRACT

Aspects of the present invention relate to an inkjet printable optical recording medium for sale to consumers. The optical medium includes an optical recording media and an inkjet receptive laminate. The optical recording media includes at least a transparent base material. The inkjet receptive laminate is bonded to the optical media and provides an inkjet receptive surface. With this in mind, the inkjet receptive laminate is characterized as exhibiting a Waterfast Optical Density Loss Percent Value of not more than 10%. In other embodiments, the Waterfast Optical Density Loss Percent Value is not less than 5%. In other embodiments, the inkjet receptive surface has a Dmin Value of not more than 0.10, a Brightness Value of at least 90%, and/or a BFR Value of not more than 16.

### CROSS-REFERENCE TO RELATED APPLICATIONS

This application claims priority to U.S. Provisional Patent Application Ser. No. 60/638,654, filed Dec. 22, 2004 and entitled “Optical Media with Laminated Inkjet Receptor”, the entirety of which is incorporated herein by reference.

### BACKGROUND OF THE INVENTION

The present invention relates to optical media. More particularly, it relates to optical recording media having a laminated inkjet receptor for receiving ink from an inkjet printer.

Optical recording media such as optical discs (e.g., CD, CD-R, DVD, HD-DVD, Blu-Ray, etc.) are popular formats for storing data or information. For example, music, programs, movies, etc., can be provided or saved in digital format on an optical medium for play back or other access by a user. In many instances, content is pre-recorded on to the optical media prior to consumer purchase. So that consumers can readily identify the recorded content, in addition to other packaging (e.g., jewel case), manufacturers typically create a stylized visual displays on a face of the optical media itself. As a point of reference, most pre-recorded optical media is comprised of a transparent base material (e.g., polycarbonate). Data is “recorded” on a surface of the base material in the form of pits or valleys. A reflective layer (e.g., aluminum, silver, or gold) is deposited over this same side of the base material, followed by a protective lacquer coating. Once hardened, a visual display is readily screen printed on to this protective layer. Alternatively, for example with DVDs, two, thinner base material substrates are provided; depending upon a particular design (e.g., DVD-5, DVD-9, DVD-R, DVD-RW, etc.), one or more reflective and/or semi-reflective substrates are also formed. Regardless, a screen printed display is printed onto an exterior surface.

More recently, “blank” optical recording media has become prevalent, affording consumers the opportunity to record desired information. Blank optical recording media is highly similar in construction to pre-recorded optical media, except that an organic dye data layer is provided (e.g., with CD-R applications, the dye data layer is sandwiched between the reflective layer and the base material), and is capable of forming and maintaining data-defining pits when processed by an appropriate recording device. The evolution of recordable optical media and corresponding recording equipment technology has resulted in users being able to create high quality recordings. Much like pre-recorded optical media, consumers desire the ability to create a visual display on a face of the media that otherwise indicates the content of the stored information. Of course, consumers do not have ready access to the high-end screen printing equipment employed by pre-recorded optical media manufacturers. Instead, consumers are typically forced to hand-write information on to the media's surface with a marker or similar writing device. Unfortunately, the outer, protective layer associated with most blank optical recording media does not readily retain most inks, leading to smudging and even possibly damage to the optical media itself. In addition, many consumers desire to produce visually stylized or unique displays and/or small sized information. Under most circumstances, it is impossible to satisfy these needs when handwriting with a marker or similar device.

A more desirable solution to the above-described optical media “labeling” concern would be to generate a machine-printed image using readily available printing equipment, and in particular an inkjet printer. Inkjet printing is widely employed in multiple printing applications, one of which is printing labels. In general terms, inkjet printing is a non-impact method for producing images by the deposition of ink droplets in a pixel-by-pixel manner to an imaging-recording substrate in response to digital signals. While differing inkjet printing techniques and the ink itself play a major role in image quality, the substrate on to which the image is printed primarily dictates whether the image will be acceptable (e.g., smear, bleed, wander, etc.).

Inkjet printer manufacturers have recognized the desire by consumers to print images on to the surface of optical recording media, producing inkjet printers capable of handling common optical media formats (e.g., CD-R's). However, simply because the inkjet printer is able to process or handle an optical medium does not ensure that an acceptable image will result. One approach for providing an aqueous inkjet receptive exterior surface on optical media is to screen print or spin coat one or more UV-curable inkjet receptive layers directly on to the media itself. For example, Taiyo-Yuden markets “inkjet printable” CD-R products in accordance with this approach. While viable, the direct coat approach may not meet all consumer expectations, especially in terms of image quality, ultraviolet fade resistance, and waterfastness.

Providing a waterfast inkjet receptive optical media surface is of increasing concern in light of rapidly changing environments in which optical media are used. That is to say, as use of recordable optical media becomes more prevalent, consumers are increasingly likely to expose the media to potentially damaging conditions, and in particular liquids. Many inkjet receptive substrates cannot maintain image quality when subjected to liquids. Currently, waterfast inkjet receptive surfaces have been created by web coating processes on both paper and plastic film substrates for such applications as outdoor signage. Often waterfastness is achieved in such materials by controlling pore size and total pore (void) volume in the inkjet receptive layer. Alternatively or additionally, fixant materials (often certain hydrophilic or cationic-functional materials) and anti-humectants may also be used for this purpose. These various approaches often entail multiple coating layers comprised of low-concentration solutions and dispersions that require extensive drying and curing. Such processes are most economically accommodated using continuous (web) coating techniques, often simultaneously applying several coating layers. Such a coating line may further incorporate in-line, continuous drying, curing, and other specialized processing. Relative to optical recording media, these and other processing requirements otherwise employed to provide a waterfast inkjet receptive surface render the technique unacceptable. With the multiple coatings, drying, curing, etc., it becomes increasingly likely that the functionality/reliability of the optical media will degrade due to contamination and/or mechanical damage. Further, in light of consumer demands for lower prices, the coating approach is likely cost prohibitive.

Conversely, adhesive-backed labels can be provided for a consumer to hand place on to the optical media and then subsequently process through an inkjet printer. While known adhesive-backed labels may be highly appropriate for many applications, the end use of optical media creates additional constraints not otherwise normally present. For example, any deviation or imperfections in adhesion of the label relative to the optical medium (e.g., bubbles, peeling, warpage, etc.) can negatively affect overall flatness of the optical medium, leading to errors during use and/or damaging of the recording/play back equipment. Similarly, many available inkjet labels are too thick for use with optical media (e.g., rendering the so-labeled optical medium too thick to be handled by corresponding recording and/or play back equipment). Additionally, waterfastness and image quality remain as important issues to most consumers that are not fully satisfied by most inkjet receptive labels. In fact, the apparent failure of others to create an acceptable inkjet receptive label for optical media applications is quite likely due to these constraints.

In light of the above, a need exists for a labeling technique that provides consumer with the ability to consistently form inkjet printer-generated displays on to optical media that are waterfast and do not affect performance of the optical media or the equipment with which it is used.

### SUMMARY

Aspects of the present invention relate to an inkjet printable optical recording medium for sale to consumers. The optical medium includes an optical recording media and an inkjet receptive laminate. The optical recording media includes at least a transparent base material. The inkjet receptive laminate is bonded to the optical media and provides an inkjet receptive surface. With this in mind, the inkjet receptive laminate is characterized as exhibiting a Waterfast Optical Density Loss Percent Value of not more than 10%. In other embodiments, the Waterfast Optical Density Loss Percent Value is not less than 5%. In other embodiments, the inkjet receptive surface has a Dmin Value of not more than 0.10, a Brightness Value of at least 90%, and/or a BFR Value of not more than 16.

Other aspects of the present invention relate to a method of providing an inkjet printable optical recording medium to a consumer. The method includes providing an optical recording medium. An inkjet receptive laminate having an inkjet receptive surface is provided. The inkjet receptive laminate is bonded to the optical recording media to form an inkjet printable optical recording medium. The inkjet printable optical recording medium is packaged and then sold to a consumer, with the inkjet receptive laminate exhibiting a Waterfast Optical Density Loss Percent Value of not more than 10%. In one embodiment, the inkjet receptive laminate is bonded to the optical recording medium via an automated device in which a moving surface is used to guide the inkjet receptive laminate onto the optical recording medium.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is an enlarged, cross-sectional view of a portion of an optical medium having a laminated inkjet receptive surface in accordance with aspects of the present invention;

FIG. 2 is a top view of one embodiment in which the optical medium is in the form of a disc;

FIGS. 3A-3C schematically illustrate a system in accordance with aspects of the present invention for forming the inkjet receptive optical medium of FIG. 1;

FIG. 4 is a schematic illustration of an alternative embodiment manufacturing system in accordance with aspects of the present invention;

FIG. 5 is an enlarged, cross-sectional view of a portion of an alternative embodiment inkjet receptive optical medium in accordance with the present invention;

FIG. 6 is an enlarged, cross-sectional view of a portion of an alternative embodiment illustrating the inkjet receptive optical medium including a laminate having a bevel along an outer periphery in accordance with the present invention;

FIG. 7 is an enlarged, cross-sectional view of an alternative embodiment inkjet receptive optical medium in accordance with the present invention;

FIG. 8 is an enlarged, cross-sectional view of a portion of another alternative embodiment inkjet receptive optical medium in accordance with the present invention; and

FIGS. 9-12 are graphs illustrating various test results.

### DETAILED DESCRIPTION OF THE PREFERRED EMBODIMENTS

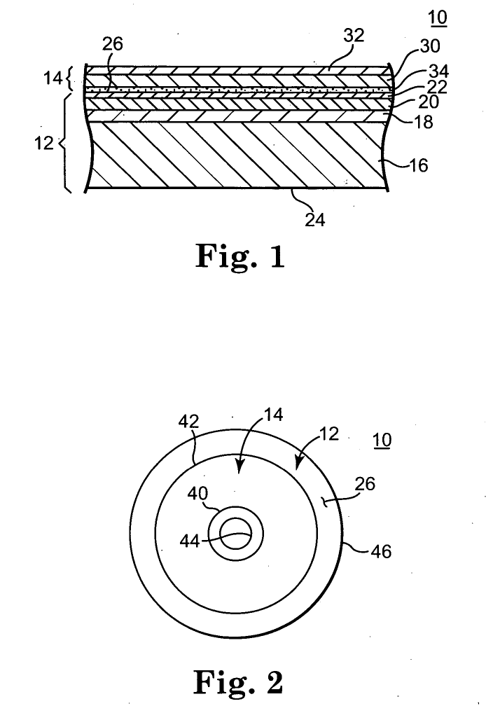

An inkjet printable optical recording medium 10 in accordance with the present invention is illustrated in FIG. 1. As a point of reference, only a portion of the inkjet printable optical medium 10 is shown, and the various layers thereof have an exaggerated thickness for ease of reference. The inkjet printable optical medium 10 generally includes an optical medium 12 and an inkjet receptive laminate 14. As described in greater detail below, the optical medium 12 can assume a wide variety of forms, as can the inkjet receptive laminate 14. In general terms, however, the inkjet receptive laminate 14 is capable of receiving and maintaining inkjet printed images and exhibits good waterfast characteristics.

The optical medium 12 can be any available optical media used for recording and/or play back of stored information, and is typically in the form of a disc. By way of example, but in no way limiting, the optical medium 12 can be a CD, CD-R, DVD, HD-DVD, Blu-Ray, etc., and can be manufactured pursuant to available techniques. With this in mind, and in one embodiment, the optical medium 12 is a CD-R and includes a transparent base material 16, a dye layer 18, a reflective layer 20, and a protective sealant 22. Each of the components 16-22 can assume any form associated with useful optical media. With this in mind, in one embodiment, the dye layer 18 is an organic dye data layer adapted to form and maintain pits or valleys representative of data during a recording operation and is applied to a side opposite a first side 24 of the base material 16 that is otherwise formed of a transparent material such as polycarbonate. The reflective layer 20 can be any acceptable material (e.g., aluminum, silver, gold, etc.) and is formed over the dye layer 18. Finally, the protective sealant 22 can be any type known in the art, and is applied over the reflective layer 20. For example, the protective sealant 22 can be a polyacrylate. In alternative embodiments, one or more of the dye layer 18, reflective layer 20 and/or protective sealant 22 can be eliminated. For example, where the optical medium is a pre-recorded CD, the dye layer 18 need not be provided. Similarly, the protective sealant 22 may not be necessary for certain applications, such as where the optical medium 12 is a DVD (it being understood that with DVD media, two polycarbonate or similar base materials are bonded to one another, thus providing appropriate protection). Even further, and as described below, the inkjet receptive laminate 14 can replace one or more of the dye layer 18, reflective layer 20 and/or protective sealant 22. Regardless, a second side 26 is defined opposite the first side 24 of the base material 16. As a point of reference, in the one embodiment of FIG. 1, the protective sealant 22 defines the second side 26.

With the above-described general description of the optical medium 12 in mind, in the embodiment of FIG. 1, the inkjet receptive laminate 14 includes a substrate 30 and an inkjet receptive surface 32. In general terms, the inkjet receptive surface 32 is formed on or by the substrate 30, with the substrate 30 affixed to the second side 26 of the optical medium 12 (e.g., to the protective sealant 22) such as with an adhesive 34.

In one embodiment, the substrate 30 can be any of those normally employed for inkjet receptors, such as paper, resin-coated paper, plastics such as polyester-type resins such as polyester terephthalate (PET) or polyester naphthalate (PEN), polyethylene resins, polypropylene resins, polyolefin resins, vinyl chloride resins, polycarbonate resins, various glass materials, and known microporous materials. Antioxidants, antistatic agents, plasticizers and/or other known additives can be incorporated into the substrate 30, if desired. In one embodiment, it is preferred that the substrate 30 be comprised of a synthetic scrim (i.e., scrim comprised of polymeric fibers) or a polymeric film(s) (e.g., polyethylene, polypropylene, polyester terephthalate, vinyl chloride, etc.) as opposed to paper (i.e., greater than 10% cellulose fiber by weight) because synthetic scrims and polymeric films more closely match the thermal and hygroscopic expansion/contraction characteristics of polycarbonate or other typical optical media plastic materials. Because differential rates of dimensional change between the inkjet receptive laminate 14 and the optical media surface 26 are thus minimized in the case of synthetic scrims or polymeric films, the inherent risk of delamination of the inkjet receptive laminate 14 from the optical media surface 26 and/or induced warpage of the optical medium 12 is thus reduced. In addition, a paper substrate has the disadvantage of being inherently more hygroscopic than synthetic scrims or polymeric films, generally increasing the quantity of free water to be managed in proximity to an image formed on the inkjet receptive surface 32. Absorbed water in a paper substrate 30 may also compromise the bond strength between the adhesive 34 and the substrate 30, increasing delamination susceptibility. Further, a paper substrate 30 may be generally prone to compromised structural integrity upon prolonged water exposure, and would thus be susceptible to potentially catastrophic failure (e.g., erosion, substrate disintegration, etc.).

Regardless of composition, the substrate 30 is highly flat (on the order of 1 nm-10 nm RMS roughness), and is formed to a thickness appropriate for application to the optical medium 12. In one embodiment, the substrate 30 has a thickness in the range of 0.01-15 mils, more preferably in the range of 0.1-5 mils, and even more preferably in the range of 0.1-3 mils, and in one preferred embodiment, a thickness of less than 2 mils. It has been surprisingly found that when applied to a “standard” optical medium (e.g., a CD-R or DVD), a substrate thickness of less than 5 mils will not negatively affect use of the inkjet receptive optical medium 10 with a recording or play back device. Alternatively, and as described in greater detail below, the substrate 30 can have an elevated thickness (e.g., greater than 15 mils) in conjunction with a “non-standard” optical medium. In one embodiment, the substrate 30 is selected and configured such that the inkjet receptive laminate 14 is highly flexible so as to minimize the impact, if any, on a desired rigidity of the optical medium 12. For example, in one embodiment, the laminate 14 exhibits a flexible rigidity of not more than 400 mg/μm, preferably not more than 350 mg/μm, more preferably not more than 300 mg/μm. This is in stark contrast to commercially available optical media labels that are all believed to exhibit a flexural rigidity on the order of 450-700 mg/μm. While the substrate 30 is illustrated in FIG. 1 as being a single material layer, in alternative embodiments, the substrate 30 can include two or more layers.

In one embodiment, the inkjet receptive surface 32 is formed as a coating on the substrate 30 (e.g., continuous coating, drying, and curing of one or more solutions and/or dispersions). With this approach, the inkjet receptive surface 32 can comprise known inkjet receptive materials, such as inorganic particles (e.g., silica, alumina, etc.) and a binder, such as polyvinyl alcohol, polyvinyl pyrrolidinone, polyvinyl acetate, polyethyl oxazoline, and gelatin to name but a few. The inkjet receptive surface 32 can also contain organic beads or polymeric micro-porous structures without inorganic filler particles. While the inkjet receptive surface 32 is shown in FIG. 1 as being a single layer, in alterative embodiments, the inkjet receptive surface 32 can consist of two or more layers.

The inkjet receptive laminate 14 is preferably highly white or silver. As such, the substrate 30, the inkjet receptive surface 32, or both, include a filler material such as titanium dioxide, barium sulfate, calcium carbonate, aluminum oxide, and/or silicon dioxide to name but a few.

The adhesive 34 can assume a variety of forms, and is specifically selected to ensure complete integrity of the inkjet receptive laminate 14 relative to the optical medium 12, and thus is a function of the material used for the substrate 30 as well as the material present on the second side 26 of the optical medium 12. In particular, and in one embodiment the adhesive 34 is selected such that the substrate 30 will not peel relative to the optical medium 12 at the edges of the substrate 30 at ambient, high temperatures (on the order of at least 55° C., more preferably at least 70° C.), low temperatures (on the order of 0° C., more preferably −20° C., even more preferably −35° C.), high humidity (on the order of at least 75% RH, more preferably at least 85% RH, more preferably at least 95% RH) or with aging (e.g., adhesive integrity will not deteriorate in terms of peel strength of 190 N/m for at least 1000 hours at 55° C./75% RH, more preferably at 55° C./85% RH, even more preferably at 70° C./85% RH, and even more preferably at 80° C./85% RH); the substrate 30 will not bubble; the adhesive 34 will not induce warp to the optical medium 12 due to shrinkage or creep; the adhesive 34 will not ooze from under the substrate 30 under any conditions; the adhesive 34 will not add an appreciable odor to the inkjet receptive laminate 14; the adhesive 34 will not migrate through, or cause fissures in, or otherwise damage the optical medium 12 (e.g., where the optical medium 12 is a CD, the adhesive 34 will not damage the acrylate protective sealant 22, the reflective layer 20, or the dye layer 18); and the adhesive 34 will not degrade under test conditions of high temperature, low temperature, humidity, or light exposure. With these constraints in mind, exemplary adhesives 34 include pressure-sensitive adhesives such as acrylate-based adhesives (e.g., poly-butyl-acrylate or poly-2-ethylhexyl-acrylate adhesive), UV-curable adhesives such as Dymax 488, thermal cure adhesives, and two-part reactive adhesives (e.g., epoxies, urethane-type adhesives, etc.).

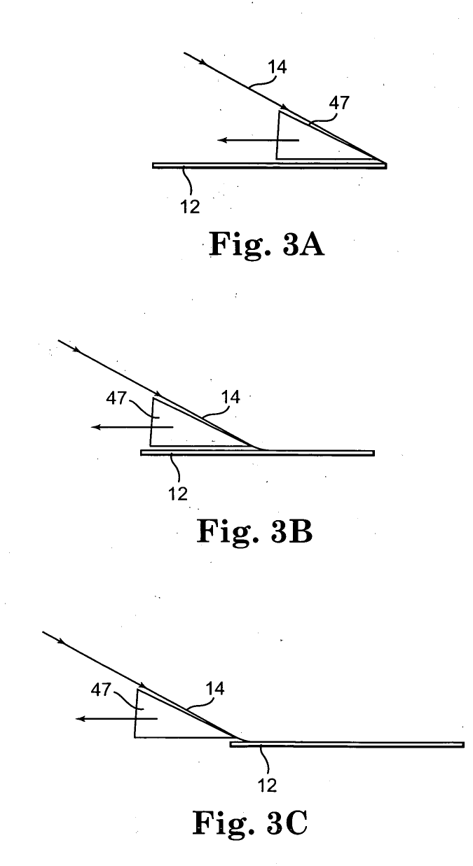

Formation of the inkjet receptive optical medium 10 is a function of the adhesive 34 employed with the inkjet receptive laminate 14. In general terms, and in one embodiment, the optical medium 12 is formed apart from the inkjet receptive laminate 14. Once formed, the inkjet receptive laminate 14 is cut (either contact or non-contact (e.g., laser) cutting) or punched to size and then applied to the optical medium 12. FIG. 2 illustrates one embodiment in which the optical medium 12 is in the form of a disc. With this construction, the inkjet receptive laminate 14 is cut/punched to define an inner diameter 40 and an outer diameter 42. The inner diameter 40 is selected to be larger than an inner diameter 44 of the optical medium 12, where as the outer diameter 42 is smaller than an outer diameter 46 of the optical medium 12. Regardless, the inkjet receptive laminate 14 is then adhered or laminated to the optical medium 12. For example, in one embodiment where the adhesive 34 (FIG. 1) is a pressure-sensitive adhesive, equipment is used to precisely align the inkjet receptive laminate 14 over the second side 26 of the optical medium 12 and then press the adhesive 34 onto the second side 26, resulting in a complete bond. Where the adhesive 34 is UV-curable, the UV-curable adhesive 34 is first UV activated, followed by placement of the inkjet receptive laminate onto the optical medium 12. Alternatively, the inkjet receptive laminate 14 is first aligned relative to the optical medium 12, and the article is subjected to UV radiation to cure the adhesive 34, again resulting in a complete bond between the inkjet receptive laminate 14 relative to the optical medium 12.

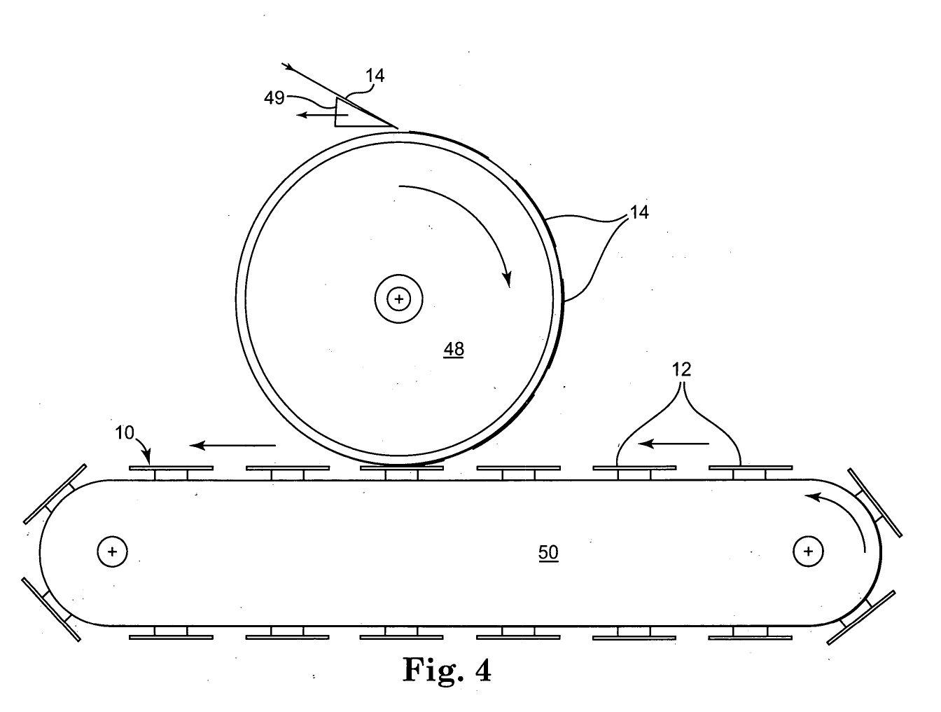

A variety of different manufacturing techniques can be employed to apply the inkjet receptive laminate 14 to the optical medium 12. In one embodiment, and with additional reference to FIG. 3, the inkjet receptive laminate (or “label film”) 14 is peeled onto a surface of the optical medium 12 via a moving peeler bar 47. The peeler bar 47 moves relative to the optical medium 12 (i.e., transitions to and between the positions “1”, “2”, and “3” in FIG. 3) at the same speed the inkjet receptive laminate 14 is peeled from the peeler bar 47. The optical medium 12 (or “target”) remains stationary. With this approach, cantilevering is minimized and maximum support is provided to the otherwise thin laminate 14.

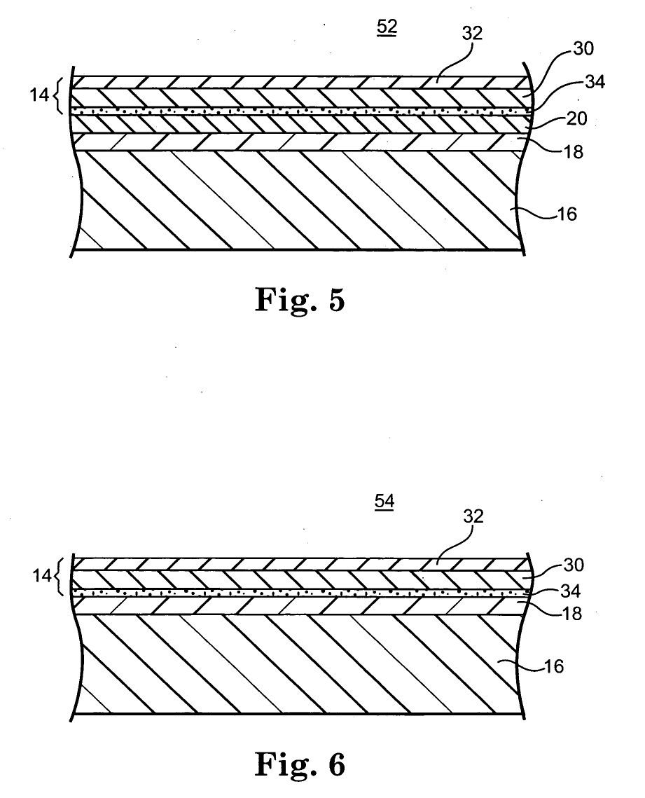

Alternatively, and with reference to FIG. 4, a continuously moving wheel 48, a peeler bar 49, and a carousel 50 are employed to continuously apply the inkjet receptive laminates (or “labels”) 14 to multiple optical media (or “targets”) 12. The wheel 48 maintains a zero relative motion between the laminate 14 once peeled from the peeler bar 49 relative to the corresponding optical medium 12, thus providing maximum productivity and minimal manufacturing costs. In one embodiment, a pitch between the laminates 14 via the peeler bar 49 matches the pitch of the optical media 12 relative to the carousel 50. If this is not the case, the speed-matching must occur during the laminate application process, which may be more difficult to accomplish. Alternatively, the optical media 12 can remain stationary (e.g., the carousel 50 is eliminated). Regardless, the system of FIG. 4 can further include a device (not shown) for sensing a location of the laminate(s) 14 on the wheel 48 prior to application to a particular one of the optical media 12. For example, the sensing device can be one or more of a line scanning camera or an array of optical sensors. With these or similar instruments, the sensing device can further sense a shape of the laminate 14 on the wheel 48 prior to application to the optical medium 12, with information from the sensing device being processed by a controller (not shown) that, in response, moves the wheel 48 axially and rotationally to properly position the laminate 14 relative to a particular one of the optical media 12, varies a speed of the wheel 48 relative to the optical medium 12 in question to stretch or compress the laminate 14 to a desired shape, or both.

Regardless of the exact automated processing employed, the resultant inkjet printable optical recording medium 10 (FIG. 1) is virtually free of bubbles at the media 12/laminate 14 interface. In one embodiment, the selected adhesive 34 (FIG. 1) and automated manufacturing technique results in less than 10 bubbles, having a diameter of less than 5 mm, along the media 12/laminate 14 interface. Further, in one embodiment, the selected automated manufacturing technique is characterized by a positional accuracy that results in the inkjet receptive surface 32 (FIG. 1) exhibiting an inner diameter runout of not more than 0.040 inch, preferably not more than 0.020 inch, and more preferably not more than 0.010 inch. Further, the inkjet receptive laminate 14 is, in one embodiment, configured and assembled to the optical medium 12 in a manner that does not negatively affect a desired moment of inertia of the resultant inkjet printable optical recording medium 10. For example, in one embodiment, the medium 10 exhibits a moment of inertia of less than 6.1×10⁻⁵ kg-m².

Regardless, the resultant inkjet printable optical recording medium 10 is packaged (either individually or as a boxed set) and made available for sale to a consumer. The consumer simply removes the medium 10 from the packaging, and can then use the inkjet printable optical recording medium 10 as desired. To this end, the consumer/user can immediately print indicia onto the inkjet receptive surface 32 using an inkjet printer; that is to say, the consumer/user is not required to assemble a separate label before or after inkjet printing.

Upon final assembly and returning to FIG. 1, the inkjet receptive optical medium 10 fully complies with all performance requirements associated with the particular optical medium 12 format (e.g., complies with Orange Book standards). Further, in some embodiments, the inkjet receptive laminate 14, and in particular the inkjet receptive surface 32, has a low background density with high brightness and whiteness/silverness; is characterized by high levels of color saturation for all colors (i.e., C (cyan), M (magenta), Y (yellow), and K (CMY composite black)); provides sharp resolution of all colors against a white or silver background; provides sharp resolution of all colors as they adjoin/abut other colors—especially a CMY composite black; exhibits waterfastness (e.g., high resistance to color bleed or smearing when water droplets are wiped and/or blotted from the medium 10 surface and high resistance to color bleed when medium 10 is stored at high humidity as described below); exhibits resistance to color fade when medium 10 is exposed to light and/or heat (as determined by the UV fade testing described below); exhibits resistance to image loss due to scratching, abrasion, or marring; and exhibits high peel strength as described below. These characteristics are quantified as follows.

Dmin Value

Minimum color density (“Dmin Value”) is the color density of the inkjet receptive surface 32 prior to inkjet printing of indicia/images. An ideal “pure white” surface has a Dmin Value of 0. With this in mind, in one embodiment, the inkjet receptive laminate 14, when measured at the inkjet receptive surface 32, exhibits a Dmin Value of not more than 0.10, more preferably not more than 0.07.

Brightness Value

In some embodiments, the inkjet receptive laminate 14, when viewed at the inkjet receptive surface 32, is highly bright prior to inkjet printing. A “Brightness Value” of the surface 32 prior to printing can be determined as the average of percent reflectance of blue light directed onto the inkjet receptive surface 32 relative to a magnesium oxide reference, as measured at a wavelength at or about 457 nm, of four readings on the surface 32. An ideal “pure white” surface has a Brightness Value of 100%. With this in mind, in one embodiment, the inkjet receptive laminate 14, when measured at the inkjet receptive surface 32, exhibits a Brightness Value of at least 90%, preferably at least 95%, more preferably at least 100%.

Whiteness (L* Value)

In some embodiments, the inkjet receptive laminate 14, viewed at the inkjet receptive surface 32, is highly white prior to receiving inkjet printing. A whiteness or “L* Value” of the laminate 14 at the surface 32 prior to printing can be determined by measuring L*a*b per CIELab color space definition using a densitometer/spectrometer (e.g., an X-Rite Model 528 densitometer/spectrometer), and is the average of eight points measured on the inkjet receptive surface 32. With this in mind, in one embodiment, the inkjet receptive laminate 14, when measured at the inkjet receptive surface 32, exhibits a L* Value of more than 95.0, preferably not less than 95.5, and more preferably not less than 96.0. This is in contrast to known inkjet printable optical recording media, as well as labels for use with optical media, all of which are believed to have an L* Value not exceeding 95.

Color Uniformity (ΔE Value)

In some embodiments, the inkjet receptive laminate 14, when viewed at the inkjet receptive surface 32, has a highly uniform color prior to receiving inkjet printing. A color uniformity or “ΔE Value” of the laminate 14 at the inkjet receptive surface 32 prior to inkjet printing is the distance between two points in the CIELab color space calculated using the following formula: sqrt((L₁-L₂)²+(a₁+a₂)²+(b₁+b₂)²), and is the range of eight points measured on the inkjet receptive surface 32. With this in mind, in one embodiment, the inkjet receptive laminate 14, when measured at the inkjet receptive surface 32, exhibits a ΔE Value of not more than 2.0, preferably not more than 1.75. This is in contrast to known inkjet printable optical recording media, as well as labels for use with optical media, all of which are believed to have a ΔE Value of greater than 2.0 (and in some instances, in excess of 20.0).

Nitrogen Adsorption Value

In some embodiments, the inkjet receptive surface 32 is highly amenable to permanently retaining inkjet printed inks by providing an elevated nitrogen accessible adsorption area as compared to an apparent area of the surface 32. A Nitrogen Adsorption Value of the surface 32 can be defined as the ratio of the nitrogen accessible adsorption area to the apparent area of the surface as measured by the Brunauer-Emmett-Teller (BET) model. With this in mind, in one embodiment, the inkjet receptive surface 32 exhibits a Nitrogen Adsorption Value of greater than 0.2 m²/in², preferably greater than 0.4 m²/in², and more preferably greater than 0.8 m²/in².

Inorganic Particle Loading Value

In some embodiments, the inkjet receptive surface 32 has a relatively significant inorganic particle loading for retaining inkjet printed inks. An Inorganic Particle Loading Value for the inkjet receptive surface 32 can be determined by measuring an initial weight of the inject receptive surface 32 as removed from the substrate 30, vaporizing the organic component of the inkjet receptive surface 32 in an appropriate device (e.g., a TGA tester), and then re-weighing the inkjet receptive surface 32. The Inorganic Particle Loading Value is then designated as a percentage, calculated by (Final Weight/Initial Weight)×100. With this in mind, in one embodiment, the inkjet receptive surface 32 exhibits an Inorganic Particle Loading Value of more than 15%, preferably more than 25%, preferably less than 75%, and preferably in the range of 15%-75%.

Waterfast Optical Density Loss Percent Value

The inkjet receptive laminate 14, and in particular the inkjet receptive surface 32, is in some embodiments characterized as being waterfast, whereby inkjet printed indicia printed onto the surface 32 will not significantly degrade when exposed to water. This attribute can be quantified by comparing an optical density of inkjet printed indicia printed on the surface 32 before and after exposure to water. In particular, a Waterfast Optical Density Loss Percent Value can be determined by first creating 100% saturation color swatches for the primary colors of cyan (C), magenta (M), yellow (Y), CMY composite black (K or V), MY composite red (R), CY composite green (G), and CM composite blue (B) on the surface 32. 1957 USAF resolution test patterns are also imaged to the surface 32 in CMY composite black on white. The images are allowed to dry for three minutes and an optical density of the images is then measured. Because densities of various colors used will inherently differ, a composite or mean optical density value for all colors is determined (“Initial Composite Density”). Approximately 1 mil of deionized water is then placed on the CMYK color swatches. The water is allowed to stand for 10 seconds and then blotted off with a standard wipe cellulose-based art blotter. The blotter is not rubbed against the sample, but simply brought vertically into and out of contact with the sample surface. Blotter contact time is 2 seconds. Blotter pressure is 25 grams/square inch. The mean or composite color saturation density is then measured on both the sample surface (“Final Composite Density”) and on the blotter. A Waterfast Optical Density Loss Percent Value is then determined as: ((Initial Composite Density−Final Composite Density)/Initial Composite Density)×100. Alternatively, a Waterfast Optical Density Loss Value can be designated as the composite color saturation density of the blotter.

With the above in mind, in one embodiment, the inkjet receptive laminate 14, and in particular the inkjet receptive surface 32, exhibits a Waterfast Optical Density Loss Percent Value of not more than 10%, preferably not more than 7.5%, more preferably not more than 5%. In other embodiments, the inkjet receptive laminate 14, and in particular, the inkjet receptive surface 32, exhibits a Waterfast Optical Density Loss Value of not more than 0.4, preferably not more than 0.3, and more preferably not more than 0.2.

UV Fade Optical Density Loss Percent Value

The inkjet receptive surface 32 is, in some embodiments, characterized as being UV fade resistant, whereby inkjet printed indicia printed onto the surface 32 will not significantly degrade when exposed to ultraviolet (UV) light. This attribute can be quantified by comparing an optical density of inkjet printed indicia printed on the surface 32 before and after exposure to UV light. In particular, a UV Fade Optical Density Loss Percent Value can be determined by first creating 100% saturation color swatches for the primary colors of cyan (C), magenta (M), yellow (Y), CMY composite black (K or V), MY composite red (R), CY composite green (G), and CM composite blue (B) on the surface 32. 1957 USAF resolution test patterns are also imaged to the surface 32 in CMY composite black on white. Once dried, a composite or mean optical density of the images is then measured (“Initial Composite Density”). The imaged sample is then placed 19 mm below the surfaces of two Sylvania F40/Daylight 6500 K, 2150 lumen initial output, 48 inch long/1 inch diameter, fluorescent light bulbs (Sylvania part number 24774) that are spaced by 55 mm, center-to-center. The combined UV power output of these two bulbs (for wavelengths less than 400 nm) is 0.688 watts. The white reflector enclosing the bulbs has an opening that provides a target area of 1858 cm², giving an area power density of 3.70×10⁻⁴ W/cm². Color saturation density is measured after 72-hours of UV exposure (“Final Composite Density”). The UV Fade Optical Density Loss Percent Value is then determined as: ((Initial Composite Density−Final Composite Density)/Initial Composite Density)×100.

With the above in mind, in one embodiment, the inkjet receptive laminate 14, and in particular the inkjet receptive surface 32, exhibits a UV Fade Optical Density Loss Percent Value of not more than 15%, preferably not more than 10%.

Resolution Value

Relative resolution measurements are made by ranking the smallest legible feature on a standard printed 1951 USAF resolution test pattern. The rating is comprised of whole numbers followed by decimal fractions (e.g., −1.3). The whole numbers (those preceding the decimal place) describe sub-sets of the test pattern. As these numbers increase, the sub-sets are graduating to smaller feature sizes implying better resolution (e.g., −1.0 represents smaller features (better resolution) than −2.0). The decimal fraction of the rating describes the rank within a sub-set; larger numbers describe features of smaller size within a sub-set (e.g., −1.7 represents smaller features (better resolution) than −1.3). Thus, resolution ratings cannot be compared as though they were single numbers. The whole numbers of the ratings must first be compared as described. If these are equal, the decimal portions of the ratings are compared as a more refined discriminator. With this in mind, in one embodiment, the inkjet receptive laminate 14, and in particular the inkjet receptive surface 32, exhibits a Resolution Value of at least −1.5, more preferably at least −2.1, even more preferably at least −2.3.

BFR Value

As described above, the inkjet receptive laminate 14 preferably exhibits high resistance to color bleed under normal and even extreme use or storage conditions. To this end, “bleed” can be evaluated according to the following test. Printed images are created on the inkjet receptive surface 32 using 100% color saturation of white, cyan (C), magenta (M), and yellow (Y) line patterns within a black (composite CMY) background. These patterns within the black background are referred to as white-on-black (W-B), cyan-on-black (C-B), magenta-on-black (M-B), and yellow-on-black (Y-B), respectively. Images are created using an HP Deskjet 5150 print engine and factory default driver settings with disabled enhancement options. Each color line pattern is comprised of four line widths: 2-point, 4-point, 8-point, and 16-point. The measured printed widths of these lines are 0.032 mm, 0.064 mm, 0.128 mm, and 0.256 mm, respectively. Line widths intermediate between these widths, larger than these widths, or smaller than these widths can also be constructed for improved test resolution/sensitivity/discrimination and/or increased range. Each line width of each color is printed having line directions oriented in the vertical, horizontal, 45° diagonal set at a positive slope with respect to horizontal, and 45° diagonal set at a negative slope with respect to horizontal. Line lengths are 4 mm. The high ink load of the composite black background tends to migrate (or “bleed”) into the colored line areas. As this occurs, the lines become occluded with black color. black field resolution value (“BFR Value”) is estimated as the minimum line width (in units of points) for which less than 10% of any line length (i.e., any line in any direction) was completely occluded; that is, greater than 90% of the line length retained some visible width of the original line color (white, C, M, or Y) when viewed under 12 power magnification. A composite BFR Value is the average of the ratings for these four line color groups. Thus, a lower BFR Value represent better print quality.

With this test protocol in mind, and in accordance with one embodiment of the present invention, the inkjet receptive laminate 14, and in particular the inkjet receptive surface 32, preferably exhibits a BFR Value of each individual line color group and/or a Composite BFR Value of all line groups of less than or equal to 30, more preferably a BFR Value or Composite BFR Value of less than or equal to 16, more preferably a BFR Value or Composite BFR Value of less than or equal to 8, even more preferably a BFR Value or Composite BFR Value of less than or equal to 4, even more preferably a BFR Value or Composite BFR Value of less than or equal to 2, and even most preferably a BFR Value or Composite BFR Value of less than or equal to 1. These preferred BFR Values and Composite BFR Values are, in one embodiment, exhibited under each and all of the following conditions: within 5-10 minutes after printing; 24 hours after printing (stored under room conditions of 18-20° C. and 35-65% RH); after 72-hours after printing an exposure to 40° C. and 85% RH; after 72-hours exposure to 55° C. and 85% RH; and after 72-hours exposure to 70° C. and 85% RH. It should be noted that “bleed” is herein technically most preferably defined as no increase in BFR Value or Composite BFR Value due to time and environmental effects (i.e., no change), second most preferably as an increase in BFR Value or Composite BFR Value due to time and environmental effects less than or equal to 100%, third most preferably as an increase in BFR Value or Composite BFR Value due to time and environmental effects less than or equal to 200%, fourth most preferably as an increase in BFR Value or Composite BFR Value due to time and environmental effects less than or equal to 400%, fifth most preferably as an increase in BFR Value or Composite BFR Value due to time and environmental effects less than or equal to 800%.

Drying Time

In some embodiments, the inkjet receptive laminate 14, and in particular the inkjet receptive surface 32, is characterized by facilitating rapid drying of inkjet printed ink (under normal environmental conditions of 18-20° C. and 35-65% RH). By way of reference, inkjet printed onto a surface is considered “dry” when the printed ink is not transferred to a cotton swab when rubbed. With this in mind, in one embodiment, the inkjet receptive surface 32 is characterized as achieving, under normal environmental conditions, an inkjet printed ink drying time of less than 3 minutes, preferably less than 1 minute, and more preferably less than 30 seconds.

Peel Strength Value

As previously described, in one embodiment, the interface between the inkjet receptive laminate 14 and the optical medium 12 is characterized by a high peel strength (via, for example, interface between the adhesive 34 and the optical medium 12). In particular, the peel strength is such that the inkjet receptive laminate 14, and in particular the inkjet receptive surface 32, remains adhered to the optical medium 12 with no subsequent failures under normal or even extreme use and/or storage conditions. With this in mind, one technique for evaluating bond or peel strength (Peel Strength Value) is as follows: a one-half inch wide strip of the inkjet receptive laminate is cut using two razor blades fixed in an appropriate spacer block. For adhesive types other than pressure sensitive adhesive (PSA), the strip can be bonded by best practice approximating that to be used in manufacture. For samples having a PSA, the release liner covering the PSA is removed to expose the PSA coating. The strip is then introduced to the target substrate (such as an unlabeled CD-R on the side opposite the data read/write side), beginning at one end of the sample strip and using a rolling motion of the hand with 0.5 kilogram of load so as to avoid introduction of entrapped air bubbles beneath the laminated film. A 2 inch wide soft rubber roller under 2 kilograms load is then rolled down the length of the strip at a rate of 2 inches per second to complete mounting/bonding of the sample. An unattached free end of the sample strip is then attached to one set of jaws on an Instron Model 5543 extensiometer and the substrate onto which the sample is bonded (such as an CD-R) is attached to the other set such that the peel angle is 180° (i.e., the bonded strip is peeled directly back upon/over itself). The draw rate is 1 centimeter per minute. The peel force (i.e., “load force”) is continuously monitored as 1 inch of bonded sample as peeled from the substrate. Minimum, maximum, and average values of peel force are then determined. With this testing technique in mind, in one embodiment, the inkjet receptive laminate 14 in accordance with the present invention exhibits the following peel force criteria set forth in Table 1 below:

TABLE 1

| | Fifth Most | | | | |
|---|---|---|---|---|---|
| | preferred | Fourth Most | Third Most | Second Most | Most |
| | Range | Preferred | Preferred | Preferred | Preferred |
| Characteristic | (grams- | Range | Range | Range | Range |
| Peel Force | force) | (grams-force) | (grams-force) | (grams-force) | (grams-force) |
| Minimum | >50 | >150 | >350 | >550 | >590 |
| Maximum | >100 | >190 | >400 | >600 | >690 |
| Mean (Peel | >75 | >160 | >360 | >575 | >620 |
| Strength Value) | | | | | |

Each of the above, preferred peel strength criteria are, in one embodiment, achieved in any or all of the following cases: within 5-10 minutes after initiating adhesion; 24 hours after initiating adhesion (stored under room conditions of 18-20° C. and 35-65% RH); 72-hours after initiating adhesion and exposure to 40° C. and 85% RH; 72-hours after initiating adhesion and exposure to 55° C. and 85% RH; and 72-hours after initiating adhesion and exposure to 70° C. and 85% RH.

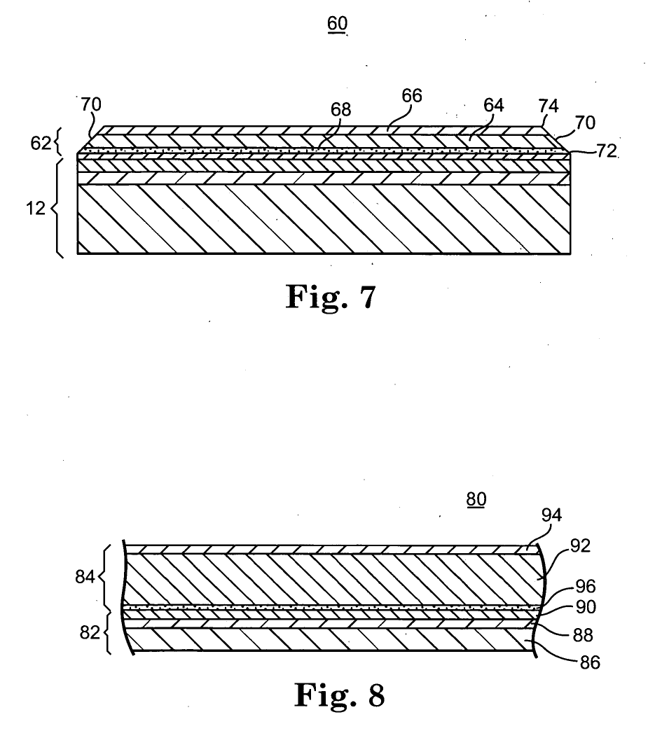

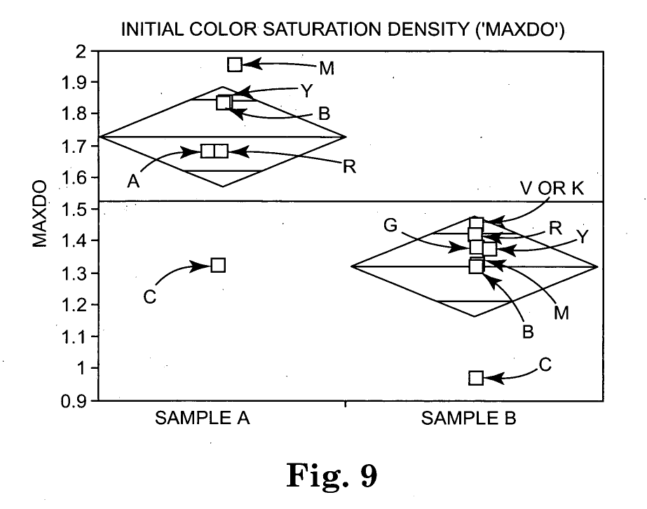

In addition to the above benefits, the inkjet receptive laminate 14 can augment protection of the reflective layer 20 otherwise covered by the protective sealant 22. This augmented protection can include protecting the reflective layer 20 from physical damage as well as UV light and/or IR radiation damage. In fact, in an alternative embodiment inkjet receptive optical recording medium 52 shown in FIG. 5, the protective sealant 22 (FIG. 1) can be eliminated, with the inkjet receptive laminate 14 being applied directly on to the reflective layer 20. This potential benefit is of particular usefulness with DVD applications, whereby the “standard” DVD configuration does not include a protective sealant, and the reflective layer 20 and the dye layer 18 are embedded/sandwiched within the polycarbonate base material 16. With this approach, the inkjet receptive laminate 14 would be applied directly on to an exterior of the base material 16. In a related alternative embodiment shown in FIG. 6, the reflective layer 20 (FIG. 1) is also eliminated, with the inkjet receptive laminate 14 being configured to provide necessary reflectivity for proper operation (e.g., recording and play back) of the inkjet receptive optical medium 54. In another alternative embodiment not specifically illustrated, the inkjet receptive laminate 14 is configured to provided reflectivity and a recordable layer (e.g., a layer able to form pits when processed by a recording device) such that the inkjet receptive laminate 14 replaces the dye layer 16 (FIG. 6) and the reflective layer 20 (FIG. 1).

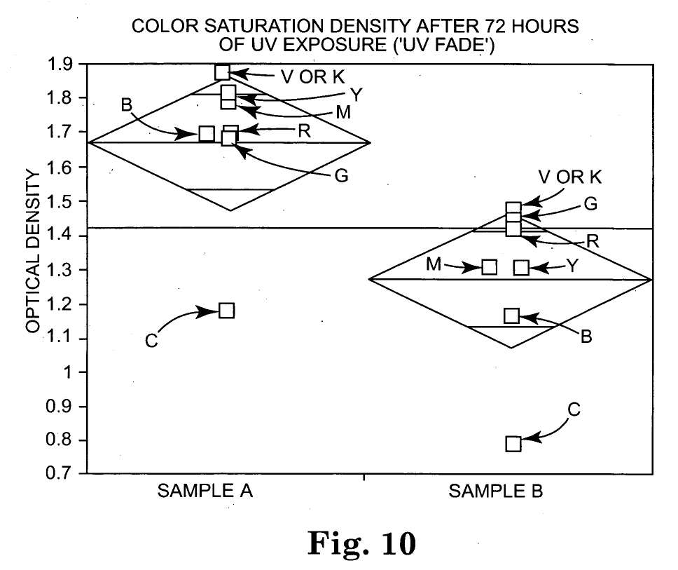

Yet another alternative embodiment inkjet receptive optical recording medium 60 is illustrated in cross-section in FIG. 7. The inkjet receptive optical medium 60 is highly similar to the inkjet receptive optical medium 10 (FIG. 1) previously described, and includes the optical medium 12 and an inkjet receptive laminate 62. The inkjet receptive laminate 62 can be similar to the inkjet receptive laminate 14 (FIG. 1) previously described, and includes a substrate 64, an inkjet receptive surface 66 and an adhesive 68. Any of the materials previously described for the substrate 30, inkjet receptive surface 32 and the adhesive 34 of FIG. 1 are applicable. With the embodiment of FIG. 7, however, the inkjet receptive laminate 62 includes a bevel 70 along an outer periphery thereof. In particular, the inkjet receptive laminate 62 is formed such that an outer diameter decreases from a first edge 72 to a second edge 74. An angle defined by the bevel 70 is preferably uniform along a periphery of the inkjet receptive laminate 62, and is in the range of 10°-60°. With this alternative embodiment, the bevel 70 greatly reduces the likelihood that the inkjet receptive laminate 62 will tear or otherwise be damaged when the inkjet receptive optical medium 60 is handled by various equipment (e.g., inkjet printer, recording equipment, play back equipment, disc storage containers, etc.). For example, the bevel 70 can reduce functional interference with recorders and players that otherwise receive or introduce the media 60 through a relatively thin entrance slot or have small thickness tolerance mechanical handling components. The bevel 70 further enhances an overall aesthetic appearance of the inkjet receptive optical medium 60 in that a user (not shown) will not readily perceive the presence of the inkjet receptive laminate 62.

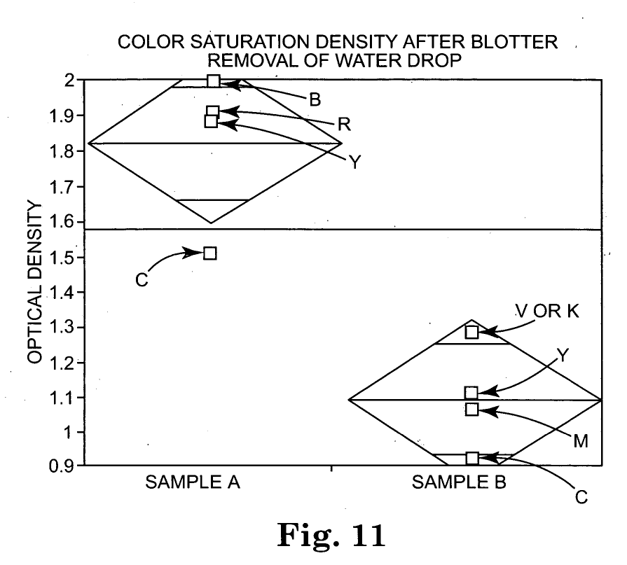

Yet another alternative embodiment inkjet receptive optical recording medium 80 is shown in FIG. 8. The inkjet receptive optical medium generally includes an optical medium 82 and an inkjet receptive laminate 84. As with the optical medium 12 of FIG. 1, the optical medium 82 can generally assume any form appropriate for a particular application (e.g., CD, CD-R, DVD, HD-DVD, Blu-Ray, etc.) and includes a base material 86 (e.g., polycarbonate), a dye layer 88, and a reflective layer 90 (it being recalled that for certain applications, the reflective layer 90 can be eliminated and/or the dye layer 88 is embedded within a thickness of the base material 86). However, the base material 86 is of a reduced thickness as compared to the base material 16 of FIG. 1. Though not drawn to scale, the base material 86 is at least 10% thinner than a “standard” thickness otherwise associated with the particular format of the optical medium 82 (e.g., for CD-R applications, a “standard” CD-R polycarbonate base material has a thickness of about 1.2 mm; where the inkjet receptive optical medium 80 of FIG. 8 is to be used as a CD-R, the base material 86 will have a thickness of less than 1.1 mm). Conversely, the inkjet receptive laminate 84 is of an increased thickness as compared to the inkjet receptive laminate 14 of FIG. 1. In particular, the inkjet receptive laminate 84 again includes a substrate 92, an inkjet receptive surface 94 and an adhesive 96. The substrate 92 is thicker than the substrate 30 of FIG. 1, for example at least 20 mils, and exhibits enhanced stiffness due to a higher Young's modulus.

In one embodiment, manufacture of the inkjet receptive optical recording medium 80 entails separately forming the optical medium 82 and the inkjet receptive laminate 84. Because the base material 86 is relatively thin, the costs associated with the optical medium 82 are reduced as compared to a “standard”, corresponding optical medium. Once formed, the inkjet receptive laminate 84 is affixed or laminated on to the optical medium 82, resulting in the inkjet receptive optical medium 80 having an appropriate overall thickness and physical properties (e.g., stiffness) that meet or exceed specifications for the finished media format.

Alternatively, the inkjet receptive laminate 84 can first be formed, and serves as the starting point for manufacture of the inkjet receptive optical medium 80. In particular, the reflective layer 90 can be deposited on to the inkjet receptive laminate 84 (opposite the inkjet receptive surface 94); notably, with this technique, the adhesive 96 can be eliminated. Subsequently, the dye layer 88 can be deposited on to the reflective layer 90, followed by direct bonding (e.g., via an adhesive) of the base material 86 on to the dye layer 88. Conversely, an inkjet receptive optical recording medium in accordance with the present invention can be formed by providing an inkjet receptive laminate that does not include a substrate. Instead, an inkjet receptive surface can be formed on an adhesive (e.g., “PSA”) otherwise carried on release liner. Following removal of the liner, the inkjet receptive surface is bonded to an optical medium via the adhesive.

The following examples and comparative examples further describe the inkjet printable optical recording media of the invention. These examples are provided for exemplary purposes to facilitate an understanding of the invention, and should not be construed to limit the invention to the examples.

### EXAMPLES

### Example/Comparison 1

Examples/Samples A

Sample inkjet receptive optical recording media in accordance with aspects of the present invention were generated by providing an inkjet receptive laminate consisting of a high-gloss, white polyethylene terephthalate film of 5 mil thickness having an inkjet receptive coating on one side and a poly-2-ethylhexyl-acrylate adhesive on the other side. The so-formed inkjet receptive laminate was cut to define a ring having inner and outer diameters commensurate with a “standard” CD-R media. The cut laminate were than applied to the label side of CD-R optical media available from Moser Bear India Ltd. (“MBI”). The resultant media are referred to herein as “Sample A”.

Comparative Examples/Samples B

Several samples of inkjet printable CD-R media commercially offered by Taiyo-Yuden (a recognized industry quality leader in inkjet printable CD-R media) were obtained. In general terms, the Taiyo-Yuden inkjet printable CD-R media form the inkjet printable surface by direct coating (e.g., screen printing) an inkjet receptive material on to the surface of a CD-R disk. The Taiyo-Yuden comparative example samples are referred to herein as “Sample B”.

Testing

Densitometry (or optical density) measurements for each of the Sample A and Sample B samples were made using an X-Rite Model 528 densitometer/spectrometer prior to inkjet printing, following inkjet printing, and after subjecting the inkjet printed samples to prescribed conditions, as described below. For example, Dmin and Brightness Values were determined prior to inkjet printing.

Inkjet sample imaging was formed on each of the Sample A and Sample B samples using an HP Deskjet 5150 aqueous-based inkjet printer engine. 100% saturation color swatches were created for the primary colors of cyan (C), magenta (M), yellow (Y), CMY composite black (K or V), MY composite red (R), CY composite green (G), and CM composite blue (B) on the inkjet receptive surface. 1951 USAF resolution test patterns were are also imaged to the sample surface in CMY composite black on white. Following printing, Resolution Values were determined.

Results

Dmin, Brightness, and Resolution Values

The Dmin, Brightness, and Resolution Values are shown in Table 2 below. As indicated, Sample A exhibited superior Dmin, brightness, and resolution as compared to Sample B.

TABLE 2

| Parameter | Sample A | Sample B |
|---|---|---|
| Dmin Value | 0.06 | 0.11 |
| Brightness Value | 96 | 85 |
| Resolution Value | −1.1 | −2.4 |

Initial Color Saturation Optical Density (“MaxDo”)

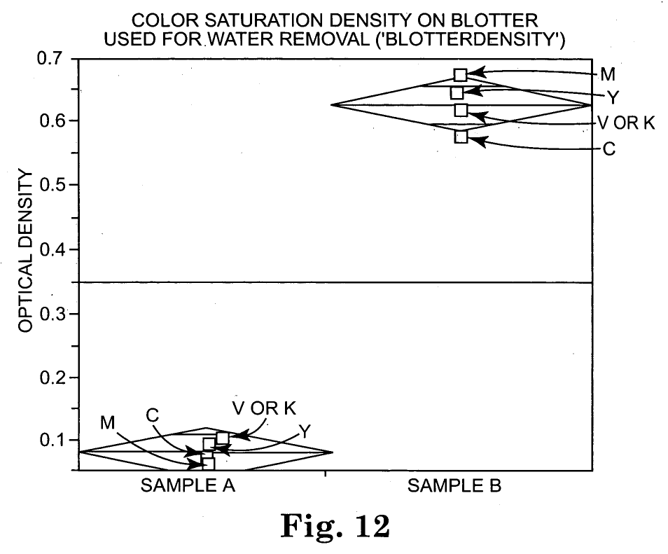

Standard densitometry was used to quantify the initial 100% color saturation swatches of Samples A and B twenty-four hours after imaging, and are reflected in FIG. 9. Individual data points are coded by the color of the test swatches from which the individual measurements were taken. The distribution of these values lie vertically scattered in two rough columns corresponding to the sample type in which they were measured. As shown by the graph of FIG. 9, the diamonds graphically describe the basic statistics of these distributions. The center horizontal line on each diamond corresponds to the mean of the data. The two shorter horizontal lines above and below the mean line are termed “overlap marks”. Overlap of the upper overlap mark of one sample distribution with the lower overlap mark of another sample distribution indicates no significant differences in the means with 95% confidence. Standard t-test statistics are tabulated in the graph in FIG. 9. Based upon the results set forth in FIG. 9, color saturation was significantly better (with greater than 95% confidence) for Sample A as compared to Sample B.

Color Saturation Density After 72 Hours of UV Exposure

FIG. 10 graphically depicts a comparison of color saturation density after 72 hours of UV exposure of Sample A versus Sample B. In particular, FIG. 10 illustrates that the Sample A color saturation was found to be significantly higher (with greater than 95% confidence) than the Sample B color saturation after 72 hours of high intensity UV exposure

Color Saturation Density After Blotter Removal of Water Drop (Waterfast Optical Density Loss Percent Value)

FIG. 11 graphically illustrates a comparison of data relating to color saturation density following blotter removal of a water drop for the samples of Sample A and Sample B. In particular, FIG. 11 illustrates the results that Sample A color saturation is found to be significantly higher (with 95% confidence) than Sample B color saturation after a water exposure followed by blotting. Further, a comparison of the data from FIGS. 9 and 11 reveals that Sample A exhibited improved color saturation density when exposed to water. In particular, Sample A exhibited a Waterfast Optical Loss Percent Value of about −5.0%, whereas Sample B exhibited a Waterfast Optical Loss Percent Value of about 24.8%.

Color Saturation Density on Blotter Used for Water Removal (Waterfast Optical Density Loss Value)

FIG. 12 graphically illustrates comparative data for the samples of Sample A and Sample B relative to the blotters removed for water removal. In particular, FIG. 12 illustrates that the color saturation transferred to the blotter from Sample A after water exposure followed by blotting is found to be significantly lower (with 95% confidence) than that transferred to the blotter for Sample B. Based on the optical density of colors found on the blotter, Sample A exhibited a Waterfast Optical Density Loss Value of 0.07, whereas Sample B exhibited a Waterfast Optical Density Loss Value of 0.62.

### Example/Comparison 2

Example/Sample C

Sample inkjet receptive optical recording media in accordance with aspects of the present invention were generated by providing an inkjet receptive laminate consisting of polypropylene gloss white film of 2.6 mil thickness having an inkjet receptive coating of Duragraphix inkjet receptor coating (available from IJ Technologies of St. Louis, Mo.) on one side and a polyacrylate adhesive on the other side (the film/adhesive being available from Ritrama of Minneapolis, Minn.). The so-formed inkjet receptive laminate was cut to define a ring having inner and outer diameters commensurate with a “standard” CD-R media. The cut laminate were then applied to the label side of CD-R optical media available from MBI. The resultant media are referred to herein a “Sample C”.

Testing

Samples C and Samples B (described above) were subjected to various testing, before and after inkjet printing, to determine characteristic values according to the methodologies described herein. For example, Inorganic Particle Loading, ΔE, *L, and Brightness Values were measured for Samples B and C. Drying time was also measured after printing. Finally, Peel Force and Nitrogen Adsorption Values were determined for Sample C. The results of these tests are provided in Table 3 below.

TABLE 3

| Parameter | Samples B | Samples C |
|---|---|---|
| Inorganic Particle Loading Value | 7.21% | 52.8% |
| ΔE Value | 2.86 | 1.52 |
| L* Value | 94.61 | 96.95 |
| Brightness Value | 81 | >100 |
| Drying Time | 960 seconds | <5 seconds |
| Peel Force Value | — | 438 g/inch |
| Nitrogen Adsorption Value | — | 1.195 m²/in² |

In light of the above, the performance of the inkjet receptive optical media in accordance with the present invention was clearly superior to that of currently available, direct coat inkjet printable optical media for all characteristics measured (Dmin, brightness, whiteness, color uniformity, nitrogen adsorption, inorganic particle loading, resolution, initial color saturation, color saturation after UV exposure, and color saturation after water exposure). Further, several other inkjet receptive laminates in accordance with the present invention were generated and compared to commercially available Taiyo-Yuden inkjet printable CD-R media, and each exhibited superior gloss, brightness, Dmin, resolution, color fidelity, and waterfastness.

Although specific embodiments have been illustrated and described herein it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate the present invention may be implemented in a very wide variety of embodiments. This application is intended to cover any adaptations or variations of the embodiments discussed herein. Further, while embodiments of inkjet printable optical recording media have been preferably described as satisfying a number of physical/performance characteristics or values, the present invention is not limited to meeting all criteria. That is to say, aspects of the present invention encompass an inkjet printable optical recording medium that meets less than all of the described criteria, and as few as one of the described criteria. Therefore it is manifestly intended that this invention be limited only by the claims and the equivalence thereof.

What is claimed is:

1. An inkjet printable optical recording medium for sale to consumers, the optical recording medium comprising:
an optical recording media including at least a transparent base material; and
an inkjet receptive laminate bonded to the optical media and providing an inkjet receptive surface;
wherein the inkjet receptive laminate exhibits a Waterfast Optical Density Loss Value of not more than 10%.

2. The inkjet printable optical recording medium of claim 1, wherein the inkjet receptive laminate exhibits a Waterfast Optical Density Loss Percent Value of not more than 5%.

3. The inkjet printable optical recording medium of claim 1, wherein the inkjet receptive laminate exhibits a Waterfast Optical Density Loss Value of not more than 0.4.

4. The inkjet printable of claim 1, wherein the inkjet receptive laminate exhibits a BFR Value of not more than 30.

5. The inkjet printable optical recording medium of claim 4, wherein the inkjet receptive laminate exhibits a BFR Value of not more than 8.

6. The inkjet printable optical recording medium of claim 4, wherein the inkjet receptive laminate exhibits the BFR Value of not more than 30 after 72 hours exposure to 70° C. and 85% RH.

7. The inkjet printable optical recording medium of claim 1, wherein the inkjet receptive laminate exhibits a Resolution Value of not less than −1.2.

8. The inkjet printable optical recording medium of claim 1, wherein the inkjet receptive laminate exhibits a Brightness Value of at least 90.

9. The inkjet printable optical recording medium of claim 8, wherein the inkjet receptive laminate exhibits a Brightness Value of at least 95.

10. The inkjet printable optical recording medium of claim 1, wherein the inkjet receptive laminate exhibits a Dmin Value of not more than 0.10.

11. The inkjet printable optical recording medium of claim 10, wherein the inkjet receptive laminate exhibits a Dmin Value of not more than 0.07.

12. The inkjet printable optical recording medium of claim 1, wherein the inkjet receptive laminate exhibits L* Value of greater than 95.0 at the inkjet receptive surface.

13. The inkjet printable optical recording medium of claim 1, wherein the inkjet receptive laminate exhibits a ΔE Value of not more than 2.0 at the inkjet receptive surface.

14. The inkjet printable optical recording medium of claim 1, wherein the inkjet receptive laminate exhibits a Nitrogen Adsorption Value of greater than 0.2 m²/in².

15. The inkjet printable optical recording medium of claim 1, wherein the inkjet receptive surface exhibits an Inorganic Particle Loading Value in the range of 15%-75%.

16. The inkjet printable optical recording medium of claim 1, wherein the inkjet receptive surface is characterized as providing a printed inkjet ink drying time of less than 3 minutes.

17. The inkjet printable optical recording medium of claim 1, wherein the inkjet receptive laminate has a flexural rigidity of not more than 400 mg/μm.

18. The inkjet printable optical recording medium of claim 1, wherein the bonding of the inkjet receptive laminate to the optical recording media is characterized by having fewer than 10 bubbles with diameters of not more than 5 mm.

19. The inkjet printable optical recording medium of claim 1, wherein bonding of the inkjet receptive laminate to the optical recording media is characterized by a runout of an inner diameter of the inkjet receptive surface of less than 0.040 inch.

20. The inkjet printable optical recording medium of claim 1, wherein the inkjet receptive laminate includes a substrate, an inkjet receptive surface formed on one side of the substrate, and an adhesive provided on an other side of the substrate opposite the inkjet receptive surface for bonding the inkjet receptive laminate onto the optical recording medium, and further wherein upon bonding to the optical medium, the adhesive exhibits a Peel Strength Value of at least 75 grams/inch.

21. The inkjet printable optical recording medium of claim 20-1, wherein the Peel Strength Value is at least 160 grams/inch.

22. The optical recording media of claim 1, wherein a perimeter edge of the inkjet receptive laminate is beveled.

23. The inkjet receptive optical recording media of claim 22, wherein the perimeter edge of the inkjet receptive laminate defines a bevel angle in the range of 10°-60°.

24. The inkjet printable optical recording media of claim 1, wherein the inkjet printable optical recording medium is a CD-R, the optical medium comprising:
a base material having a thickness of less than 1.1 mm.

25. A method of providing an inkjet printable optical recording medium to a consumer, the method comprising:
a) providing an optical recording medium;
b) providing an inkjet receptive laminate having an inkjet receptive surface;
c) bonding the inkjet receptive laminate to the optical recording medium to form an inkjet printable optical recording medium;
d) packaging the inkjet printable optical recording medium; and
e) selling the packaged inkjet printable optical recording medium to a consumer;
wherein the inkjet receptive laminate is characterized by a Waterfast Optical Density Loss Value of not more than 10%.

26. The method of claim 25, wherein step c) includes:
associating the inkjet receptive laminate with a movable surface of an automated device; and
operating the automated device to guide the movable surface adjacent the optical recording medium to apply the inkjet receptive laminate onto the optical medium.

27. The method of claim 26, wherein the movable surface is provided as part of a wheel.

28. The method of claim 27, wherein step c) further comprises:
controlling a relative speed of the wheel.

29. The method of claim 27, wherein step c) further comprises:
sensing a location of the inkjet receptive laminate relative to the wheel prior to applying the inkjet receptive laminate to the optical recording medium.
